(19) United States
(12) Patent Application Publication
(10) Pub. No.: US 2007/0131729 A1
(43) Pub. Date: Jun. 14, 2007

(54) Vehicle Organization System

(76) Inventor: Julie Kopf, Park Ridge, IL (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 11/548,350

(22) Filed: Oct. 11, 2006

Related U.S. Application Data
(60) Provisional application No. 60/725,546, filed on Oct. 11, 2005.

(51) Int. Cl. B60R 9/00; B60R 7/00

(52) U.S. Cl. 224/400; 224/901.8

(57) ABSTRACT

A vehicle organization system comprising a housing sized for placement within a vehicle. The housing has a top wall, a bottom wall, a rear wall and first and second opposed sidewalls that define a cavity. A plurality of storage units are located within the cavity and are supported by at least one of the sidewalls.

The present application claims the benefit of Provisional Patent Application No. 60/725,546, filed Oct. 11, 2005, which is hereby incorporated herein by reference.

### FIELD OF THE INVENTION

The present invention relates generally to a vehicle organization system for organizing materials and items within a vehicle.

### BACKGROUND OF THE INVENTION

Sales professionals and other professionals who travel by vehicle to call on clients typically store and transport various items and materials, such as sales literature, samples and promotional giveaways, within their vehicle. These items are quite often stored in loose boxes in the trunks or other compartments of the professional's car. Often a sales professional's trunk is packed with boxes containing items and materials strewn about in no particular order, and it is difficult for the professional to quickly obtain the materials needed for a particular client. In an attempt to organize such materials some sales professionals have attempted to use bins and crates to organize their materials. However, bins and creates are not much better than boxes for organizing materials. Therefore, there remains a need for an improved organization system for organizing materials and items within a vehicle.

### SUMMARY OF THE INVENTION

In accordance with one aspect of the present invention, a vehicle organization system including a housing sized for placement into a vehicle. The housing has a top wall, a bottom wall, and first and second opposed sidewalls that define a cavity. A plurality of storage units are disposed within the cavity wherein the storage units are supported by at least one of the sidewalls.

Another aspect of the present invention is a vehicle organization system including a housing defining a cavity that has a plurality of storage units disposed within the cavity wherein the housing is collapsible.

Yet another aspect of the present invention is a kit for assembling a vehicle organization system. The kit comprises a first blank that can be configured into a housing sized for placement into a vehicle and at least one second blank that can be configured into a storage unit which can be disposed within the housing.

### BRIEF DESCRIPTION OF THE DRAWINGS

Turning now to a more detailed description of the various embodiments of the present invention illustrated in the attached drawings, of which:

FIG. 1 is a perspective view of one embodiment of a vehicle organization system of the present invention, shown with various portions cutaway;

FIG. 1a is an enlarged cutaway view of the top wall of the vehicle organization system of FIG. 1;

FIG. 1b is an enlarged cutaway view of a storage unit and housing of the vehicle organization system of FIG. 1;

FIG. 2 is a perspective view of the vehicle organization system of FIG. 1, shown without the storage units;

FIG. 3 is a perspective view of the exterior surface of the bottom wall of the vehicle organization system of FIG. 1;

FIG. 4 is a perspective view of one embodiment of a storage unit of the vehicle organization system of FIG. 1;

FIG. 5 is a top plan view of one embodiment of a housing blank of the present invention;

FIG. 6 is a top plan view of one embodiment of a storage unit blank of the present invention;

FIG. 7 is another embodiment of the vehicle organization system of the present invention; and

FIG. 8 is the vehicle organization system of FIG. 7, shown without the storage units.

### DETAILED DESCRIPTION OF THE INVENTION

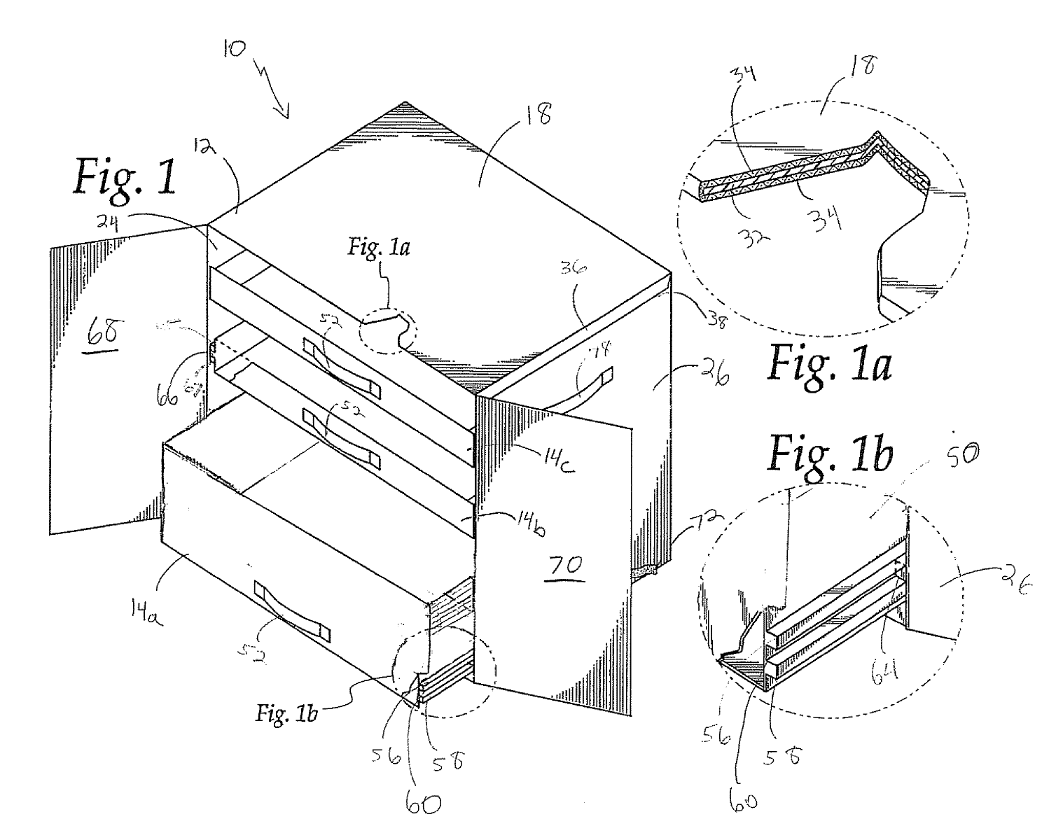

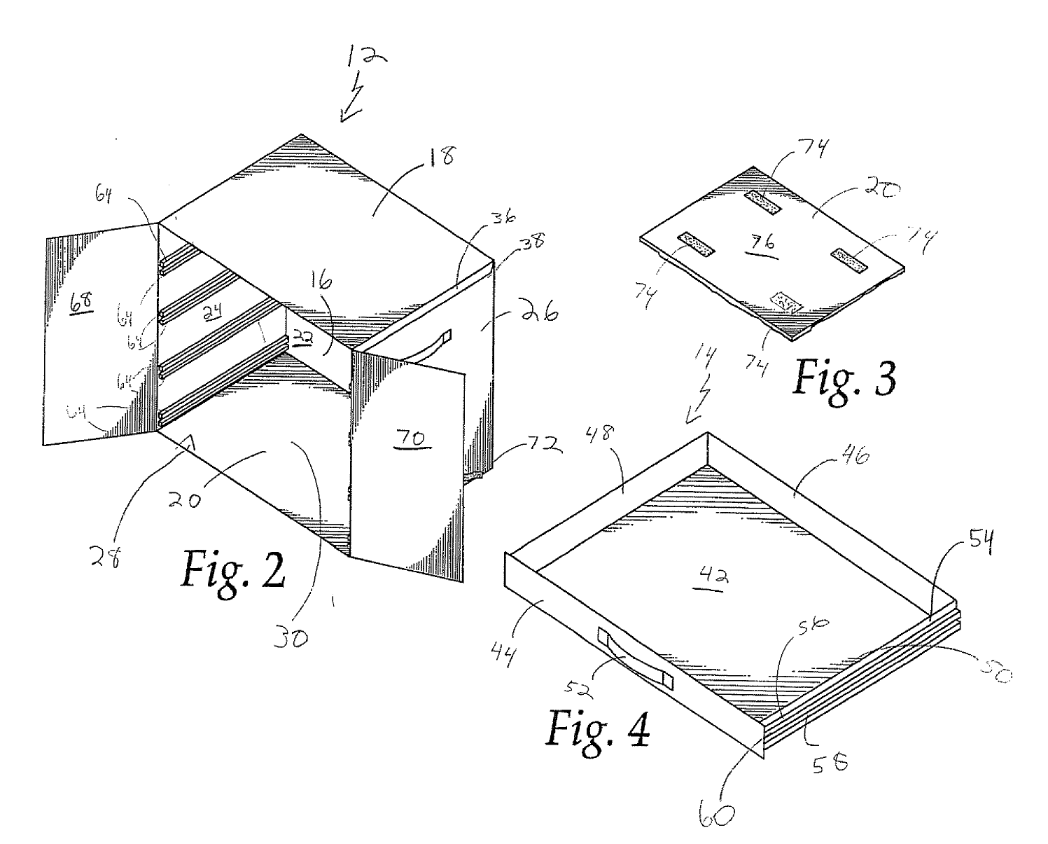

FIG. 1 generally illustrates one embodiment of a vehicle organization system of the present invention, generally designated as 10. The vehicle organization system 10 includes a cabinet or housing 12 with a plurality of storage units 14a-14c, preferably drawers, received within a cavity 16 (FIG. 2) of the housing 12. The housing 12 can comprise a top wall 18, a bottom wall 20, a rear wall 22 and first and second opposed sidewalls 24, 26 (FIG. 2). The front area 28 of the housing 12 is substantially opened or includes at least one opening 30 for receiving the plurality of storage units 14a-14c therethrough and into the cavity 16 of the housing 12.

The walls 18, 20, 22, 24, 26 of housing 12 can be a composite structure including a substrate 32 comprising a substantially rigid material, such as plastic or heavy cardboard, covered on both sides by flexible material or fabric 34, such as nylon or the like (FIG. 1a). Furthermore, each wall 18, 20, 22, 24, 26 can be integral to its adjacent walls or each wall may be secured to its adjacent wall by various fastener arrangements, such as a hook and loop fastener, snap fastener and the like, or posts and caps. For example, referring to FIGS. 1 and 2, the top wall 18 can have a flap 36 that includes a hook element of a hook and loop fastener. To secure the top wall 18 to the second sidewall 26, the hook element can engage a corresponding loop element disposed along the top edge 38 of the second sidewall 26. Alternatively, the flap 36 could include a series of female snap elements that receive a series of male snap elements located along edge 38. When the walls of the housing are secured together by some fastening arrangement, the organization system can be collapsed for storage and transport. For example, the organization system can be collapsed down to the blank 40 shown in FIG. 5, as will be described herein.

Each of the storage units 14a-14c, generically designated as 14 in FIG. 4 for illustrative purposes, can include a bottom wall 42, front wall 44, rear wall 46 and first and second opposed sidewalls 48, 50. Similar to the construction of the housing 12, the walls of the storage unit 14 can be integral or secured together by some fastening arrangement so as to make the storage unit collapsible. Additionally, the walls 42, 44, 46, 48, 50 of the storage unit 14 can also be made from a substantially rigid material covered by a flexible material or fabric. The storage units 14a-14c can have a variety of dimensions, and as shown in FIG. 1, the opening 30 and the cavity 16 of housing 12 can be configured to interchangeably receive a variety of storage units having different dimensions so that the vehicle organization system can be customizable according to the user's needs. For example, illustratively, storage unit 14a beneath storage unit 14b has twice the vertical depth of storage unit 14b, and the vehicle organization system 10 can be reconfigured so that storage unit 14a and storage unit 14b can be disposed at different locations within the cavity 16 of the housing 12. Illustratively, the vehicle organization system 10 is shown with three storage units 14a-14c. However, the vehicle organization system could contain more than three or less than three storage units, depending on the size of the housing, the size of the storage units and the desired use. It will also be understood that the storage units all can be of the same dimension and still be in accordance with the present invention.

Preferably, the storage units 14a-14c slidably engage the housing 12 so that the storage units may be at least partially slid out of the cavity 16 through the opening 30 to allow access to items and materials contained within the storage units. Each of the storage units 14a-14c can include a handle 52 to aid in sliding the storage units in and out of the housing. The sliding engagement between the storage units 14a-14c and the housing 12 can be accomplished by any means known in the art, such as by a tongue and groove assembly, wheel and channel assembly, or by any other suitable slidable engagement. In the illustrated embodiment, a tongue and groove-like arrangement is shown wherein the outer surface (not shown) of the first opposed sidewall 48 and the outer surface 54 of the second opposed sidewall 50 of the storage unit 14 each include a first protrusion 56 and a second protrusion 58 extending along the length of the respective outer surface from the front wall 44 to the rear wall 46 (FIGS. 1b and 4). The first and second protrusions 56, 58 are spaced apart to create an indent or groove 60. The internal surface 62 of the first opposed sidewall 24 and the internal surface (not shown) of the second opposed sidewall 26 of the housing 12 each include support members, preferably a plurality of protrusions or tongues 64 (FIG. 2), that corresponds to and slidably engage groove 60 between the first protrusion and the second protrusion 56, 58 (FIG. 1b). The tongues 64 support the storage units 14a-14c and allow them to be slid in and out of the housing 12. Alternatively, the tongue and groove configuration could be reversed, and each of the first and second opposed sidewalls 24, 26 of the housing 12 could include a groove, and the first and second opposed sidewalls 48, 50 of the storage unit 14 could include the tongue. For example, as illustrated in FIG. 1, storage unit 14b includes a tongue 66 and the first opposed side wall 24 includes the groove located between protrusions 65 and 67.

To close the opening 30 in the front 28 of the housing 12 and to secure the storage units 14a-14c within the cavity 16, the housing can include a door assembly having an open position and a closed position. The door assembly can include a first door 68 hingedly attached to the first sidewall 24 of the housing 12 and a second door 70 hingedly attached to the second sidewall 26 (FIGS. 1 and 2). The doors 68, 70 can substantially meet at the center of the opening 30 to close or cover the opening, keeping the storage units 14a-14c secured within the housing 12 as the vehicle is in motion. A securing member 72 can be employed to aid in maintaining the door assembly in a closed position. For example, the securing member 72 could be a hook and loop fastener, a hook and eye fastener or a latch and receiving slot. In the illustrated embodiment, for example, the securing member 72 can include a hook element connected to the second door 70 which engages a loop element located on the first door 68 (not shown).

The housing 10 can be secured to the vehicle by a variety of means. Such means can include, for example, securing or non-skid elements 74 disposed on the exterior surface 76 of the bottom wall 20 (FIG. 3). Illustratively, the bottom wall 20 includes four securing elements 74 disposed near the four corners of the exterior surface 76. However, the organization system can include any number of securing elements arranged in a variety of layouts. The securing elements 74 can be hook elements of a hook and loop fastener, textured rubber members or spiked feet, which frictionally engage a surface within the vehicle, such as the floor of a trunk. The vehicle organization system 10 can also be secured to the vehicle by attaching bungee cords to handles 78 located on each of the exterior surfaces of the opposed sidewalls 24, 26 and securing the bungee cords to a portion of the vehicle.

As mentioned above, the housing 12 and the storage units 14a-14b can be collapsible and rebuilt. For example, the housing 12 can be built from and collapsed to the blank 40 (FIG. 5). The blank 40 can include a bottom wall panel 20a hingedly connected to a rear wall panel 22a and first and second opposed sidewall panels 24a, 26a. The blank 40 can also include a top wall panel 18a hingedly connected to the rear wall panel 22a. A first door panel 68a can be hingedly connected to the first sidewall panel 24a and a second door panel 70a can be hingedly connected to the second sidewall panel 26a.

The blank 40 can include a variety of fastening members to secure the panels of the blank 40 together when the blank is configured to form the housing 12. In one embodiment, the first and second sidewall panels 24a, 26a include a hingedly connected flap 82. The flap 82 can include a variety of fastening members, such as a hook and loop element or a male or female snap element. When the blank 40 is configured into the housing 12, the fastening member on the flap 82 is fastened to a corresponding fastening member located on the rear wall panel 22a. For example, the flap 82 could include a hook element of a hook and loop fastener and the rear wall panel 22a could include a corresponding loop element. The top wall panel 18a also includes flaps 84 which have a fastening member(s) that engages a corresponding fastening member(s) disposed on the first and second sidewall panels 24a, 26a to secure the top wall panel 18a to the first and second sidewalls panels 24a, 26a when the blank 40 is configured to form the housing 12. In an alternative embodiment, the first sidewall panel 24a and the second sidewall panel 26a could include posts 86 which enter and extend through openings 88 when the blank 40 is configured into the housing 12. Caps 90 then can be secured to the posts 86 to maintain the posts within the openings 88. The caps 90 can be attached to the posts 86 by a snap-fit or the caps can threadably engage the posts.

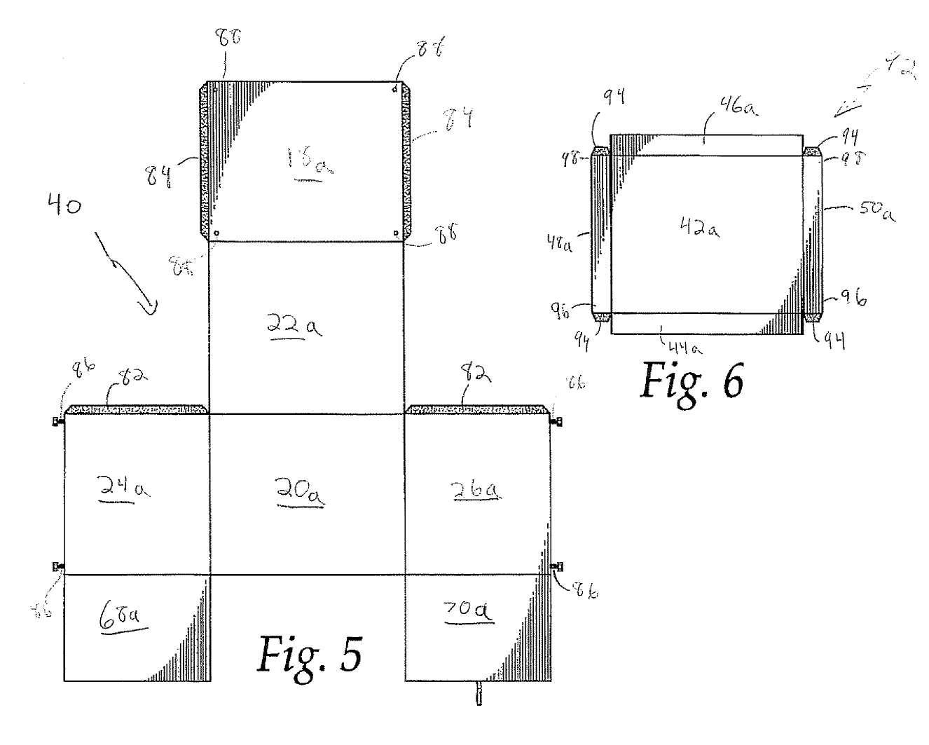

Similar to the housing 12 the storage units 14a-14c can also be built from and collapsed into blank 92 (FIG. 6). The blank 92 includes a bottom wall panel 42a, a front wall panel 44a, a rear wall panel 46a and a pair of opposing sidewall panels 48a, 50a. Each of the sidewall panels 48a, 50a can include flaps 94 connected to both the front edge 96 and the back edge 98 of the sidewall panels. The flaps 94 can be employed to secure the opposed sidewall panels 48a, 50a to the front and rear wall panels 44a, 46a when the blank 92 is configured into a storage unit 14. The flaps 94 can includes any of the fastening members described above, or any other suitable fastening member known in the art.

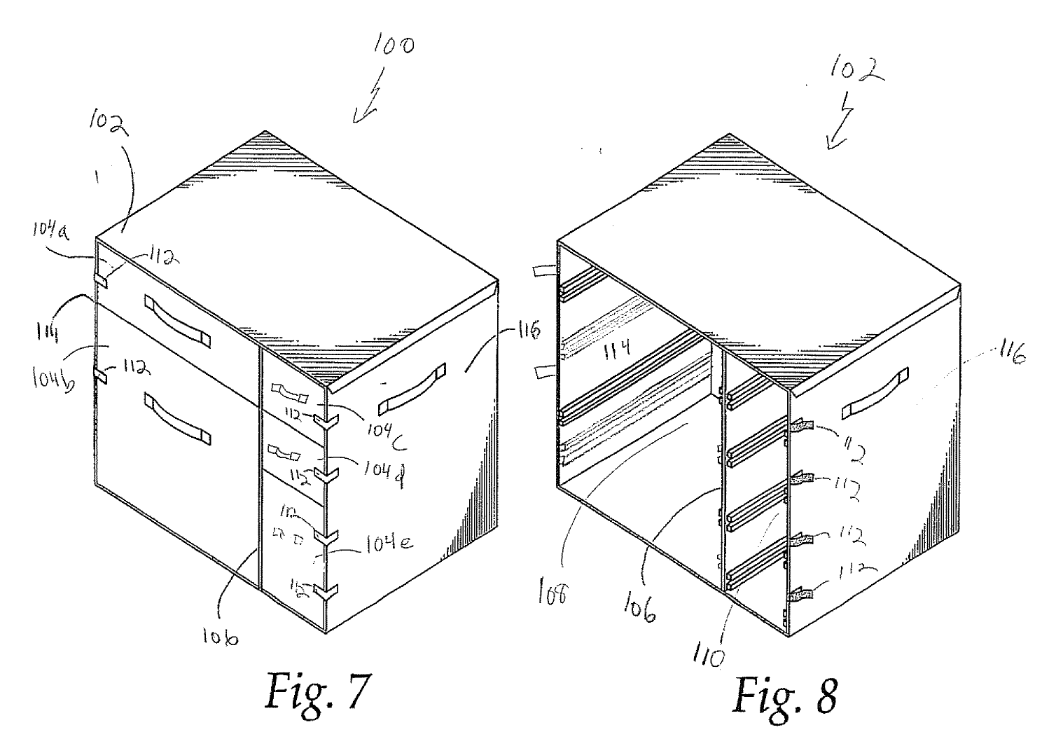

FIGS. 7 and 8 illustrate another embodiment of the organization system of the present invention, generally designated 100. The organization system 100 is similar in many aspects to the embodiment shown in FIGS. 1 and 2 and includes a housing 102 and storage units 104a-104e. In this embodiment, the housing 102 includes a dividing member 106 that divides the cavity into a first sub-cavity 108 and a second sub-cavity 110 wherein the first sub-cavity 108 receives storage units 104a and 104b, and second sub-cavity 110 receive storage units 104c-104e. Accordingly, in this embodiment, the organization system 100 can have vertically and horizontally adjacent storage units. Illustratively, the organization system includes five storage units 104a-104e of various sizes. For example, storage unit 104b is similar to a file cabinet drawer and can be sized to receive and store standard files and folders in an upright orientation. The storage unit 104a is shallower than storage unit 104b, and for example, can store files and folders lying flat. Storage units 104c, 104d are shallower and narrower than storage unit 104b, and can be sized to carry samples or writing utensils. Finally, storage unit 104e has the same width as storage units 104c, 104d, but is deeper than storage units 104c, 104d. As with the previous embodiment, the housing 102 can be designed so that the size, number and type of storage units can be customizable according to the user's need.

This embodiment also eliminates the use of a door assembly, and the storage units 104a-104e can be secured in a closed position by locking mechanisms 112 that keep the storage units closed while the vehicle is in motion. Such locking mechanisms 112 can include strips of hook elements connected to the first and second sidewalls 114,116 of the housing 102 that fasten to a corresponding loop element disposed on the storage unit. The locking mechanisms 112 could also be any other locking mechanisms known in the art, such as snap fasteners.

Preferably, the organization systems of the present invention are sized to ft within a trunk or other compartment of a vehicle. More preferably, the organization systems of the present invention are approximately half of the width of a standard trunk so that the user can choose, if desired, to use two organization systems. The two systems could have the same or different configuration. The two organization systems can be connected by a variety of fastening arrangements, such as hook and loop fasteners disposed on adjacent walls of the housings of the organization systems.

While the present invention has been described in terms of certain preferred and alternative embodiments for purposes of illustration, it is not limited to the precise embodiments shown or to the particular features, shapes or sizes illustrated. A variety of changes may be made without departing from the present invention as defined by the appended claims.

1. A vehicle organization system, comprising:
a housing sized for placement into a vehicle, said housing having a top wall, a bottom wall, and first and second opposed sidewalls that define a cavity; and
a plurality of storage units disposed within said cavity wherein said storage units are supported by at least one of said sidewalls.

2. The vehicle organization system of claim 1 in which the one sidewall includes support members for supporting the plurality of storage units.

3. The vehicle organization system of claim 1 in which the cavity is configured to interchangeably receive a variety of differently dimensioned storage units.

4. The vehicle organization system of claim 1 in which the storage units comprise drawers.

5. The vehicle organization system of claim 1 in which the storage units slidably engage the one sidewall.

6. The vehicle organization system of claim 1 in which the housing is collapsible.

7. The vehicle organization system of claim 6 in which the storage units are collapsible.

8. The vehicle organization system of claim 1 in which the walls of the housing are integral.

9. The vehicle organization system of claim 1 further including a door assembly for securing the storage units within the cavity of the housing.

10. The vehicle organization system of claim 10 in which the door assembly includes a first door connected to the first sidewall and a second door connected to the second sidewall, and a locking member releasably securing the first door and the second door in a closed position.

11. The vehicle organization system of claim 1 further including a locking mechanism for locking the storage units within the cavity.

12. The vehicle organization system of claim 1 further including a dividing member within said cavity to divide said cavity into a first sub-cavity and a second sub-cavity wherein each sub-cavity is adapted to receive a plurality of storage units.

13. The vehicle organization system of claim 1 further including a securing element for securing the housing to the vehicle.

14. A vehicle organization system, comprising:
a housing defining a cavity, and a plurality of storage units within disposed with said cavity, and wherein said housing is collapsible.

15. The vehicle organization system of claim 14 in which the storage units are collapsible.

16. A kit for assembling a vehicle organization system, comprising:
a first blank that can be configured into a housing sized for placement into a vehicle; and
at least one second blank that can be configured into a storage unit which can be disposed within the housing.

17. The kit of claim 16 in which the first blank comprising a bottom wall panel hingedly connected to a rear wall panel and first and second opposed sidewall panels, and a top wall panel hingedly connected to the rear wall panel.

18. The kit of claim 16 in which the first blank further includes fastening members for securing the panels together.

19. The kit of claim 16 wherein the at least one second blank comprises a bottom wall panel hingedly connected to a front wall panel, a rear wall panel and first and second opposed sidewall panels.

20. The kit of claim 19 in which the at least one second blank further includes fastening members for securing the panels of the second blank together.
